(19) United States
(12) Patent Application Publication
(10) Pub. No.: US 2008/0240842 A1
(43) Pub. Date: Oct. 2, 2008

(54) GLASS SEALANT APPLICATOR NOZZLE AND METHOD OF USE THEREOF

(75) Inventor: Anthony Blamer, Marysville, OH (US)

Correspondence Address: STANDLEY LAW GROUP LLP, 495 METRO PLACE SOUTH, SUITE 210, DUBLIN, OH, 43017, US

(73) Assignee: Honda Motor Co., Ltd., Tokyo (JP)

(21) Appl. No.: 11/693,493

(22) Filed: Mar. 29, 2007

(51) Int. Cl. B43K 1/06; B43M 11/06

(52) U.S. Cl. 401/265; 401/261

(57) ABSTRACT

An applicator nozzle for applying a bead of sealant or a similar material to an object, and a method of use thereof. An applicator nozzle of the present invention includes a nozzle body having a first end for connection to a supply of sealant or another flowable material, and a second end adapted to dispense said material. A trailing orifice is located at a trailing side of the applicator nozzle to dispense a trailing bead of material behind the applicator nozzle as it is moved along the object. A leading orifice is located at a leading side of the applicator nozzle to dispense a leading bead of material ahead of the applicator nozzle at least upon connection of the end of the material bead with its starting point. A continuous material bead with no gaps can thus be formed.

### BACKGROUND OF THE INVENTIVE FIELD

The present invention is directed to an applicator nozzle for applying beads of flowable materials to objects. In one particularly interesting application, the present invention is directed to an applicator nozzle for uniformly and consistently applying a bead of glass sealant to vehicle window glass prior to its installation to a vehicle. Even more particularly, an applicator nozzle of such an application is used in conjunction with an automated glass sealant application device.

It is well known to apply a bead of sealant around the periphery of a glass panel prior to its installation to a frame. Generally, whether the glass panel is, for example, a window pane or a vehicle windshield, the bead of sealant acts to secure a glass panel to the frame and also operates to prevent the intrusion of air and/or water.

Commonly, such a bead of sealant may be applied manually, such as with a caulking gun or specialized sealant tube that causes the pressurized expulsion of sealant through a nozzle. In large-scale manufacturing operations, however, it is more common for such sealant application to occur via some automated apparatus.

While such an automated apparatus may be custom-designed for a particular application, typically, automated sealant application is accomplished by means of a sealant application robot and related equipment. Related equipment may include, for example, a supply of sealant, an applicator nozzle for forming a sealant bead on a glass panel of interest, and a pump or similar device for supplying sealant under pressure to the nozzle.

In operation, such a sealant application robot typically moves to a starting point associated with a glass panel, which is commonly supported in a nesting jig or similar apparatus. Upon reaching the starting point, the robot signals the sealant pump or other sealant supplying device to transfer sealant from the sealant supply to the nozzle. Once sealant transfer begins, the robot traces out a predefined path about the glass panel. As such, a bead of sealant is robotically applied to the glass panel.

As can be understood, along with a starting point, the predefined robot path must also have a stopping point. In order to prevent air, water, and/or other substances from intruding through or around the bead of sealant once the glass panel is installed to its frame or other mount, it is desirable that the bead of sealant be unbroken. Consequently, the starting point and stopping point of the predefined robot path should be substantially the same. This should theoretically result in connection of the beginning and end of the sealant bead, and a complete seal of the glass panel in its frame.

In practice, however, obtaining a solid and unbroken sealant bead has been difficult, if not impossible. The inability to obtain an acceptable sealant bead may be attributable to several factors. First, the flowable sealant materials used are generally somewhat viscous and, therefore, tacky. Consequently, any contact therewith will tend to deform/displace the sealant bead and cause the sealant to adhere to the contacting surface. As such, it is difficult if not impossible with known sealant applicator nozzles to connect the ends of the sealant bead due to undesirable contact therewith by the applicator nozzle.

Therefore, known robotic glass sealant application techniques commonly employ a lifting of the sealant applicator nozzle prior to it reaching the starting point of the sealant bead. Unfortunately, as with deformation of the sealant bead by the applicator nozzle, this often results in an unacceptable sealant bead.

More specifically, the sealant bead is often rendered incomplete as a result of this technique because known applicator nozzles dispense sealant only from a trailing side thereof. Therefore, as the applicator nozzle is lifted to avoid contact with the starting point of the sealant bead and the flow of sealant is halted, the result is typically a gap between the endpoint and starting point of the sealant bead. Upon installation of the glass panel, this gap can allow for the undesirable infiltration of air and/or water, for example.

Consequently, it can be understood that what is needed is an improved device and method for applying a uniform and complete bead of sealant to a glass panel or other object. The present invention satisfies this need.

### SUMMARY OF THE GENERAL INVENTIVE CONCEPT

The present invention is directed to an applicator nozzle for applying a bead of material to an object of interest, and to its method of use. Of particular interest is a sealant applicator nozzle and method of use thereof that is capable of producing a uniform and complete sealant bead on a glass panel or other object. Preferably, an applicator nozzle of the present invention is used in conjunction with an automated sealant application process. An applicator nozzle of the present invention can also be used with a manual sealant application process, or with a manual or automated process for applying a bead of a non-sealant flowable material. For purposes of clarity, however, the present invention will be described further only with respect to the application of a sealant bead.

An applicator nozzle of the present invention differs from known nozzles in that it is designed to dispense sealant from both a trailing and leading orifice thereof. During the sealant application process, this design allows for a small amount of sealant to exit the leading orifice of the nozzle as the nozzle reaches the starting point of the sealant bead. As such, upon slowing and lifting of the applicator nozzle as it reaches the beginning point of the sealant bead, a leading amount of sealant is dispensed that is sufficient to connect the end of the sealant bead with its beginning. The result is the creation of a uniform and complete sealant bead with no gaps therein.

It is obvious that an applicator nozzle of the present invention could be used to apply sealant (and other materials) to a wide variety of objects. However, for purposes of clarity, the following illustrative exemplary embodiment is described for use only in the context of applying a sealant bead to a vehicle glass panel (e.g., a windshield). Similarly, while an applicator nozzle of the present invention could be used in both an automated and manual sealant application process, the following description is directed specifically to robotic application. Nothing herein should be considered to so limit the scope of the present invention, however.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1a is a perspective rear view of a known sealant applicator nozzle;

FIG. 1b is a rear elevation view of a known sealant applicator nozzle;

FIG. 2 is a perspective view of a typical gap in a sealant bead produced by the applicator nozzle of FIG. 1;

FIG. 3a is a perspective rear view of one exemplary embodiment of a sealant applicator nozzle of the present invention;

FIG. 3b is a rear elevation view of the applicator nozzle of FIG. 3a;

FIG. 3c is a right side elevation view of the applicator nozzle of FIG. 3a;

FIGS. 4a-4c depict the nozzle of FIGS. 3a-3c in the act of applying a sealant bead to a vehicle windshield; and

FIG. 5 shows the completed sealant bead produced by an applicator nozzle of the present invention and the application process of FIGS. 4a-4c.

### DETAILED DESCRIPTION OF EXEMPLARY EMBODIMENT(S)

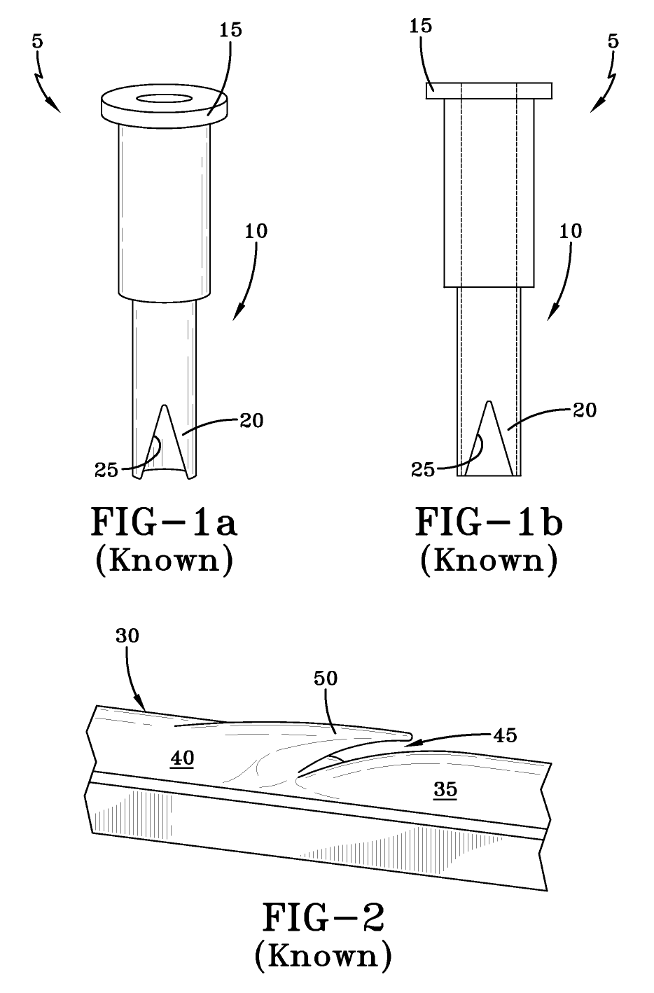

A known and typical sealant applicator nozzle 5 is shown in FIGS. 1a-1b. As can be seen, this known sealant applicator nozzle 5 has a rather elongate body 10 with a first end 15 for connection to a sealant applicator device and a second end 20 for dispensing sealant. A dispensing orifice 25 is located along a trailing surface at the second end 20 of the applicator nozzle 5. The dispensing orifice 25 acts to regulate and shape the sealant as it is dispensed. In operation, sealant is emitted from the dispensing orifice 25 and forms a sealant bead that trails behind the moving applicator nozzle 5.

Other known applicator nozzle shapes are also possible. However, like the applicator nozzle 5 shown in FIG. 1, all existing sealant applicator nozzles of which Applicant is aware have a dispensing orifice on only a trailing surface thereof.

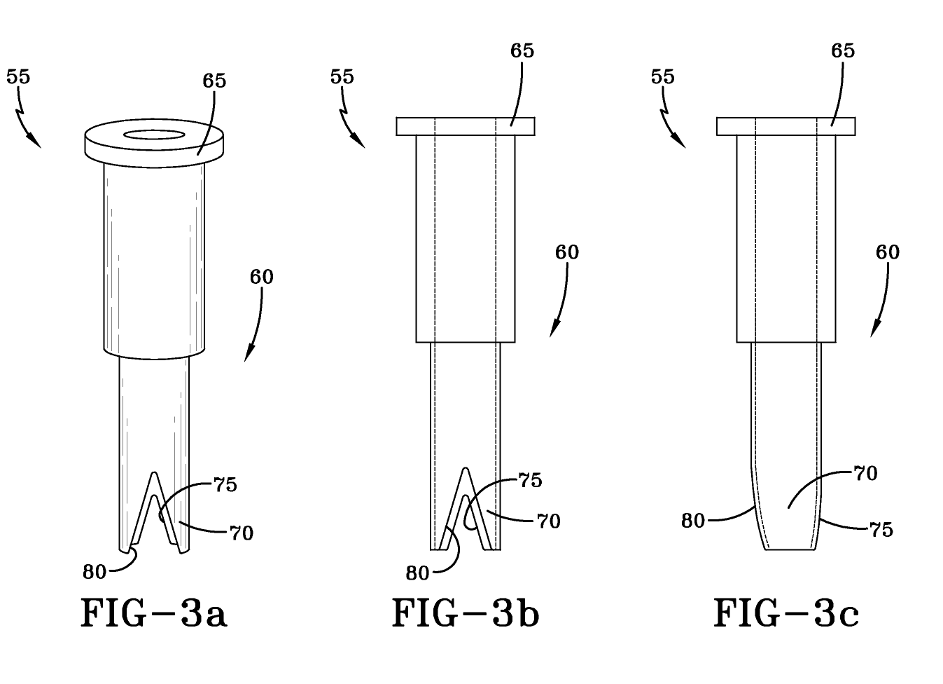

As described briefly above, such a known applicator nozzle 5 produces a trailing sealant bead as it is guided along an object. An exemplary sealant bead 30 produced by the applicator nozzle 5 of FIGS. 1a-1b is illustrated in FIG. 2. As shown, an undesirable gap 45 exists between the beginning section 35 and ending section 40 of the sealant bead 30.

As discussed above, this gap 45 results from the need to prevent the leading surface of the applicator nozzle 5 from contacting the beginning section 35 of the sealant bead 30 as application of the sealant bead is completed. If the leading surface of the applicator nozzle 5 were allowed to contact the beginning section 35 of the sealant bead 30, it can be understood that the sealant bead would be deformed and a portion thereof may stick to the applicator nozzle.

To circumvent this problem, the applicator nozzle 5 is typically lifted as it approaches the beginning section 35 of the sealant bead 30. Lifting of the applicator nozzle 5 produces a raised section 50 that can be seen at the terminus of the ending section 40 of the sealant bead 30.

In order to prevent an unacceptably large amount of sealant from collecting at the theoretical interface (desired knitpoint) between beginning and ending sections of a sealant bead, the supply of sealant is typically shut off substantially concurrently with the lifting of the applicator nozzle 5. The result of lifting a typical applicator nozzle 5 and the required cessation of sealant flow is the gap 45 shown in FIG. 2.

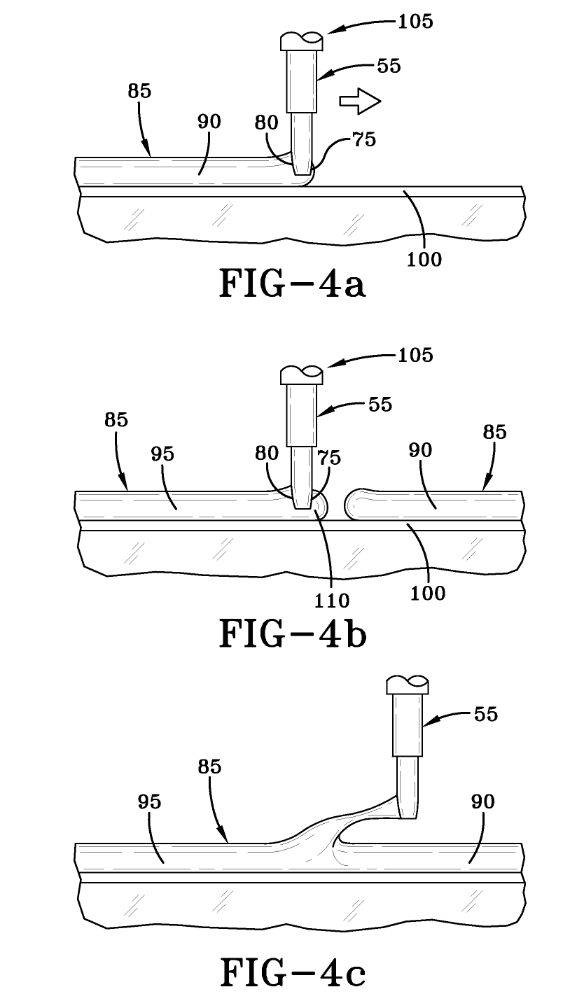

A sealant applicator nozzle of the present invention alleviates the problem illustrated in FIG. 2. One exemplary embodiment of a sealant applicator nozzle 55 of the present invention can be observed in FIGS. 3a-3c. As shown, this particular sealant applicator nozzle 55 also has a substantially elongate body 60, with a first end 65 for connection to a sealant applicator device (not shown) and a second end 70 from which sealant is dispensed.

Unlike known applicator nozzles, this applicator nozzle 55 has both a leading and trailing dispensing orifice 75, 80 residing at the second end 70 thereof. Preferably, the leading and trailing dispensing orifices 75, 80 are substantially diametrically opposed (when the nozzle has a circular cross-section) or otherwise aligned with respect to the path of travel of the nozzle 55.

The leading and trailing dispensing orifices 75, 80 of an applicator nozzle of the present invention may be of various dimensions. However, the desired size of the sealant bead will generally determine the dimensions of the trailing dispensing orifice 80. In this particular example, a sealant bead 15 mm high and 8 mm wide is desired. As such, the trailing dispensing orifice 80 has approximately the same dimensions.

Further, certain advantageous characteristics associated with the dispensing orifices are suggested by the application of fluid flow theory. For example, it has been discovered that the flow rate of sealant from the trailing dispensing orifice 80 should be approximately twice that of the flow rate of sealant from the leading dispensing orifice 75. Therefore, the dimensions of the leading dispensing orifice of an applicator nozzle of the present invention may be determined by this 2:1 flow rate ratio and the dimensions of the associated trailing dispensing orifice. Based on this flow rate ratio and the dimensions of the trailing dispensing orifice 80 of this particular applicator nozzle 55, the leading dispensing orifice 75 is approximately 10 mm high and 6 mm wide. While such a ratio of dispensing orifice flow rates may be advantageous, it should nonetheless be realized that other flow rate ratios can be employed by an applicator nozzle of the present invention.

The applicator nozzle 55 of FIGS. 3a-3c is shown in FIGS. 4a-4c in the process of applying a sealant bead 85 to a vehicle windshield 100. As shown in FIG. 4a, the applicator nozzle 55 is connected to a sealant applicator device 105, which includes a motive device for moving the applicator nozzle along an intended path (as indicated by the arrow) with respect to the wind shield 100. In this particular case, the motive device is a robot (not shown). However, it should be realized that an applicator nozzle of the present invention can be used with virtually any sealant application apparatus and/or process.

As shown in FIG. 4a, a first section 90 of the sealant bead 85 extends from some starting point on the windshield 100 in a desired direction of travel and along some predetermined path. As can be seen in FIGS. 4a-4c, the sealant bead 85 is dispensed only, or primarily, from the trailing dispensing orifice 80 as the applicator nozzle 55 is moved along the windshield 100.

FIG. 4b depicts the applicator nozzle 55 as it dispenses an ending section 95 of the sealant bead 85 to the windshield 100. As can be understood, the ending section 95 of the sealant bead 85 will have an end point that ideally connects to the starting point of the beginning section 90 of the sealant bead 85. FIGS. 4b-4c illustrate the process of making such a connection. Specifically, as the applicator nozzle 55 approaches the starting point of the beginning section of the sealant bead 85, its velocity is slowed. Slowing of the applicator nozzle 55 causes an amount of sealant 110 to be emitted from the leading dispensing orifice 75 (see FIG. 4b).

Just prior to, or just at, contact with the starting point of the beginning section 90 of the sealant bead 85, the flow of sealant is terminated and the applicator nozzle 55 is also preferably lifted. The result is that the sealant 110 emitted from the leading orifice 75 of the applicator nozzle 55 contacts the starting point of the beginning section 90 sealant bead 85, producing a joining of the ending section 95 to the beginning section of the sealant bead without an undesirable deformation thereof.

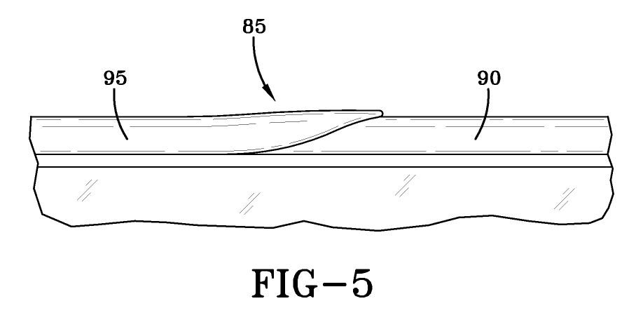

An enlarged view of the joined sections 90, 95 of the sealant bead 85 is shown in FIG. 5. As can be seen, the beginning section 90 is joined to the ending section 95 without any gap in the sealant bead 85. The ending section 95 of the sealant bead 85 may also overlap the beginning section 90 of the sealant bead as shown.

A sealant bead may be applied with an applicator nozzle of the present invention under various operating parameters. That is, the linear velocity of the applicator nozzle will likely be dependent on the size of the dispensing orifices, the pressure at which the sealant is dispensed, and the viscosity of the sealant.

For example, as shown in FIGS. 4a-4c, the applicator nozzle 55 had a linear velocity of approximately 333 mm/sec while applying the sealant bead 85. This linear velocity coincided with a sealant flow rate of approximately 20,000 mm³/sec and a sealant dispensing velocity of approximately 398 mm/sec. At this applicator nozzle linear velocity, the flow of sealant from the leading dispensing orifice 75 was generally or substantially prevented (as shown in FIG. 4a). As the applicator nozzle linear velocity was reduced, however, sealant begin to flow from the leading dispensing orifice 75 (as shown in FIG. 4b). Obviously, the combinations of applicator nozzle linear velocity, sealant flow rate, etc., are virtually limitless and, therefore, use of an applicator nozzle of the present invention is not limited to any particular application parameters.

A typical automated sealant application apparatus employs a piston pump to extract sealant from a drum or other container, whereafter it is moved through sealant supply lines to an applicator nozzle by a gear pump or similar device. Unfortunately, the outlet pressure of a piston pump inherently fluctuates during its operation. As such, the pressure and flow rate of sealant leaving the piston pump can also greatly fluctuate.

In light of this pressure fluctuation, it has been found that placing a regulator between the piston pump and gear pump is effective to provide sealant to an applicator nozzle of the present invention at a constant flow rate. While certainly not essential to use of an applicator nozzle of the present invention, the use of such a regulator can result in the application of a more consistent sealant bead. Usable regulators would be known to those skilled in the art and need not be described in detail herein.

As can be understood from the foregoing description, the use of an applicator nozzle of the present invention allows for a complete (joined/knitted) sealant bead to be applied to an object of interest. That is, the use of an applicator nozzle of the present invention allows for the creation of a sealant bead with no gap between a beginning section and ending section thereof—a result that has been generally very difficult to accomplish and even more difficult to repeat with known sealant applicator nozzles.

As can also be understood from the foregoing description, an applicator nozzle of the present invention can be of various shape and size, as can the dispensing orifices associated therewith. As such, while certain embodiments of the present invention are described in detail above for purposes of illustration, the scope of the invention is not to be considered limited by such disclosure, and modifications are possible without departing from the spirit of the invention as evidenced by the following claims:

What is claimed is:

1. An applicator nozzle for applying a bead of flowable material to an object, comprising:
a nozzle body having a first end for connection to a supply of said flowable material and a second end adapted to dispense said flowable material;
a trailing dispensing orifice at said second end of said nozzle body for emitting a trailing bead of said flowable material as said applicator nozzle is moved normally along said object; and
a leading dispensing orifice at said second end of said nozzle body for permitting an amount of said flowable material to be emitted ahead of said applicator nozzle as it is moved along said object.

2. The applicator nozzle of claim 1, wherein said flowable material is a sealant.

3. The applicator nozzle of claim 1, wherein said trailing dispensing orifice is of a larger area than said leading dispensing orifice.

4. The applicator nozzle of claim 3, wherein said trailing dispensing orifice defines an area approximately twice that of said leading dispensing orifice.

5. The applicator nozzle of claim 1, wherein sealant flows from said leading dispensing orifice during sealant bead application only when said applicator nozzle is moved at a speed that falls below some threshold value.

6. The applicator nozzle of claim 1, wherein said trailing dispensing orifice and said leading dispensing orifice are linearly aligned.

7. The applicator nozzle of claim 1, wherein said nozzle body is of substantially circular cross-section and said trailing dispensing orifice and said leading dispensing orifice are substantially diametrically opposed.

8. An applicator nozzle for applying a sealant bead to an object, comprising:
a nozzle body having a first end for connection to a pressurized supply of sealant and a second end adapted to dispense said sealant;
a dispensing orifice at a trailing side of said second end of said nozzle body for dispensing a trailing bead of sealant as said applicator nozzle is moved normally along said object; and
a dispensing orifice at a leading side of said second end of said nozzle body for permitting an amount of sealant to be emitted ahead of said applicator nozzle as said applicator nozzle is moved along said object.

9. The applicator nozzle of claim 8, wherein said dispensing orifice at said trailing side of said nozzle body is of a larger area than said dispensing orifice at said leading side of said nozzle body.

10. The applicator nozzle of claim 9, wherein said dispensing orifice at said trailing side of said nozzle body defines an area approximately twice that of the dispensing orifice at said leading side of said nozzle body.

11. The applicator nozzle of claim 8, wherein sealant flows from said dispensing orifice at said leading side of said nozzle body during sealant bead application only when said applicator nozzle is moved at a speed below some threshold value.

12. The applicator nozzle of claim 8, wherein said dispensing orifice at said trailing side of said nozzle body and said dispensing orifice at said leading side of said nozzle body are linearly aligned.

13. The applicator nozzle of claim 8, wherein said nozzle body is of substantially circular cross-section and said dispensing orifice at said trailing side of said nozzle body and said dispensing orifice at said leading side of said nozzle body are substantially diametrically opposed.

14. An applicator nozzle for applying a continuous sealant bead to an object, comprising:
a nozzle body having a first end for connection to a pressurized supply of sealant and a second end adapted to dispense said sealant, said nozzle body also having a leading side and a trailing side as defined by an intended direction of travel of said applicator nozzle during sealant bead application;
a trailing dispensing orifice located at said trailing side of said second end of said nozzle body for dispensing a bead of sealant behind said nozzle body as said applicator nozzle is moved normally along said object; and
a leading dispensing orifice at said leading side of said second end of said nozzle body for permitting the dispensing of an amount of sealant ahead of said nozzle body only when said applicator nozzle is moved along said object at less than normal speed;
wherein said leading dispensing orifice permits the dispensing of a sufficient amount of sealant ahead of said applicator nozzle to connect the end of said sealant bead to the beginning of said sealant bead.

15. The applicator nozzle of claim 14, wherein said trailing dispensing orifice is of a larger area than said leading dispensing orifice.

16. The applicator nozzle of claim 15, wherein said trailing dispensing orifice defines an area approximately twice that of said leading dispensing orifice.

17. The applicator nozzle of claim 14, wherein sealant flows from said leading dispensing orifice only when said applicator nozzle is moved at a speed below some threshold value.

18. The applicator nozzle of claim 14, wherein said trailing dispensing orifice and said leading dispensing orifice are linearly aligned.

19. The applicator nozzle of claim 14, wherein said nozzle body is of substantially circular cross-section and said trailing dispensing orifice and said leading dispensing orifice are substantially diametrically opposed.

20. A method of applying a continuous bead of sealant to an object, comprising:
providing a sealant applicator nozzle, said sealant applicator nozzle further comprising:
a nozzle body having a first end for connection to a pressurized supply of sealant and a second end adapted to dispense said sealant,
a trailing dispensing orifice located at a trailing side of said second end of said nozzle body for dispensing a bead of sealant behind said nozzle body as said applicator nozzle is moved along said object, and
a leading dispensing orifice at a leading side of said second end of said nozzle body for dispensing an amount of sealant ahead of said nozzle body as said applicator nozzle is moved along said object,
placing a pressurized supply of sealant in communication with said sealant applicator nozzle;
locating said sealant applicator nozzle to a sealant bead starting point on said object;
initiating a flow of sealant through said sealant applicator nozzle;
moving said sealant applicator nozzle in a forward direction over said object and along some predetermined path that terminates substantially at said sealant bead starting point, movement of said sealant applicator nozzle occurring at a sufficient linear velocity to produce a trailing bead of sealant from said trailing dispensing orifice while substantially preventing the flow of sealant from said leading dispensing orifice;
upon nearing said sealant bead starting point, reducing the linear velocity of said sealant applicator nozzle such that an amount of sealant is dispensed ahead of said sealant applicator nozzle;
continuing the forward motion of said sealant applicator nozzle until said amount of sealant being dispensed ahead of said sealant applicator nozzle reaches said sealant bead starting point;
terminating the flow of sealant; and
lifting said sealant applicator nozzle to a point above said sealant bead so as to avoid deforming said starting point of said sealant bead;
whereby a continuous sealant bead is formed by the connection of its ending point with its starting point.

21. The method of claim 20, further comprising continuing the forward motion of said sealant applicator nozzle for some distance after the lifting thereof, such that an overlap of the starting point of said sealant bead by the ending point of said sealant bead is ensured.

22. The method of claim 20, wherein said trailing dispensing orifice of said applicator nozzle is of a larger area than said leading dispensing orifice thereof.

23. The method of claim 20, wherein said trailing dispensing orifice defines an area approximately twice that of said leading dispensing orifice.
